(19) United States
(12) Patent Application Publication
(10) Pub. No.: US 2015/0042822 A1
(43) Pub. Date: Feb. 12, 2015

(54) INFLATABLE PHOTO BOOTH

(71) Applicant: Tu Le, Playa Vista, CA (US)

(72) Inventor: Tu Le, Playa Vista, CA (US)

(21) Appl. No.: 14/184,498

(22) Filed: Feb. 19, 2014

Related U.S. Application Data
(60) Provisional application No. 61/865,073, filed on Aug. 12, 2013.

(51) Int. Cl. E04H 14/00; E04H 15/20; H04N 5/232; G03B 15/07; H04N 5/225

(52) U.S. Cl. CPC E04H 14/00; G03B 15/07; H04N 5/2252; H04N 5/2256; H04N 5/23293; E04H 15/20
USPC 348/207.1; 348/370; 348/333.01

(57) ABSTRACT

An inflatable photo booth, including in-wall lighting, supplemental lighting, monitor and controls is provided for facilitation of photography. The photo booth, and all supplemental lighting and controls is easily transported. The various lighting fixtures included with the booth are controlled by a hand held controller that allows a user to adjust the color and illumination intensity of the light used for taking photographs of the user. Controller, and/or a separate processor, may be connected to a network so that that the photographs taken may be communicated via email or posted to social media.

### CROSS-REFERENCES TO RELATED APPLICATIONS

This application claims priority from U.S. Provisional Application No. 61/865,073, filed Aug. 12, 2013 incorporated by reference in its entirety.

### BACKGROUND

This invention relates to photographic devices, and more particularly, to an inflatable all-in-one photographic device that can be inflated and deflated quickly.

A camera is an optical instrument used in recording and capturing still images, moving images, and even video content. The photographic content is stored on light sensitive film or other media, either directly inside the camera or off-site at a separate location. A lens placed at the front of the front of the camera functions to allow incoming light to project onto the recordable media for image capture and storage. Flash and other lighting technology is used in recording image and video content in a variety of settings where natural light is insufficient for the user's purposes. Technological advancements have made digital cameras commonplace in photography, providing the user with instant access to the recorded content for viewing and editing.

A printer is an electronic device that employs various methods for printing physical copies of recorded photographic media in various resolutions. Printers receive photographic content from computers or cameras via direct or indirect connection. Printers employ various method of printing images, including, but not limited to, laser, inject, toner, and cartridge. Multiple options for ink are also available for printers, each designed to meet the user's specific needs.

A photo booth is an enclosed area of undetermined size comprised of a photographic device, printing device, seating area, privacy wall or curtain, and other peripheral devices and attachments used to create and print photos on location. These devices are typically housed in a single unit, known as a kiosk, or multiple locations within the photo booth. Photo booths are typically self-service devices, but more complex photo booths may be accompanied by a photo booth attendant who can help customers access and manipulate any advances features that may be available. Photo booths are generally operated by the customer and accept various payment methods. Once the photo booth has taken the series of photos paid for, the photo booth will automatically start printing the process.

While photo booths exist in the prior art, they are often stationary devices that cannot be quickly and easily assembled and disassembled. Although newer technology has reduced the size of optical devices, printers, monitors, and processors, photo booths have remained the same size. Therefore, a need exists for a photo booth that takes advantage of newer technology by reducing its size, providing portability that provides fewer restrictions on transportation, more flexibility for suitable locations and usage, and quicker assembly and disassembly. The present invention satisfies these, and other needs.

### SUMMARY OF THE INVENTION

In its most general aspect, the present invention provides an inflatable photo booth that takes advantage of newer technology by reducing its size and providing portability with a quick assembly and disassembly process. The present invention offers convenience and flexibility over traditional photo booths by providing photo booth services directly at a user's location. Furthermore, the present invention is very secure and robust when disassembled and deflated. This is accomplished by creating an inflatable booth that can be inflated to its full size when in use, but deflated to a fraction of that size when not in use for ease in transportation. The inflatable photo booth is ideal for transit when in a deflated state. Having no discernible shape and extremely small size provides for transportation and relocation of the photo booth to almost any location or event imaginable.

In another aspect, when the photo booth is in its inflated state, the inflatable photo booth provides recessed structures allowing placement for all internal peripheral devices, including the camera, flash, monitor, and touch screen. The user typically operates the inflatable photo booth using a processor-implemented system to control the photo taking process, as well as allowing a user to obtain either a printed copy of the photo or an electronic file containing the photograph. In some aspects, the photo booth may also provide for publishing the photo or photos online through a connection to the Internet.

In another aspect, the present invention includes n inflatable photo booth, comprising: an inflatable three dimensional structure defined by a wall and a ceiling, the wall and ceiling each having an inside panel facing an interior of the inflatable three dimensional structure and an outside panel, the inside panel and the outside panel being attached to each other such that a space is formed between the inside and outside panels, the space providing a reservoir for the containment of air; a source of air for filling the reservoir so as to inflate the three dimensional structure; a variable source of light disposed about a bottom of the wall and in between the inside panel and the outside panel of the wall; a first opening disposed in the wall to provide access to the interior of the inflatable three dimensional structure; a camera/display assembly disposed in a second opening disposed in the wall such that a rear side of the camera/display assembly is visible from the exterior of the three dimensional structure; and, a controller for controlling the variable source of light and the camera/display assembly.

In one alternative aspect, the three dimensional structure has a rectangular shape. In another alternative aspect, the source for air is a fan or blower. In still another alternative aspect, the variable source of light is an LED panel.

In yet another aspect, the camera/display assembly includes a camera and a touch screen display mounted on a front side of the camera/display assembly, the front side of the camera/display assembly facing into the interior of the inflatable three dimensional structure. In still another aspect, the camera/display assembly includes a touch screen display mounted on a rear side of the camera/display assembly, the touch screen being visible from the exterior of the inflatable three dimensional structure.

In a further aspect, the inflatable photo booth further comprises a metal frame disposed in the interior of the inflatable three dimensional structure.

In another aspect, the camera/display assembly has an upper module supported on a base by a vertically adjustable member. In still another aspect, the upper module has a housing to which are mounted a camera and a touch screen display.

In an alternative aspect, the camera and touch screen display are mounted on a front side of the upper module, and further including a second touch screen display mounted on a rear side of the upper module.

In another alternative aspect, the distance between the upper module and the base can be adjusted by adjusting the vertically adjustable member.

In yet another aspect, the base includes a processor and a memory associated with the processor, the processor configured by software commands to receive commands from the controller and/or camera/display assembly to control operation of the variable source of light and camera/display assembly.

In still another aspect, the controller includes a processor and a touch screen display controlled by the processor, the touch screen display controlled by the processor to display an adjustable color wheel and an adjustable brightness slider bar. In another aspect, the controller includes communication means for communication with the processor in the base of the camera/display assembly to provide the processor in the base with input for use by the processor in the base to control operation of the variable source of light and the camera/display assembly.

In one alternative aspect, the adjustable color wheel is manipulable by a user to adjust a color value of light provided by the variable source of light. In another aspect, the adjustable brightness slider bar is manipulable by a user to adjust a brightness value of light provided by the variable source of light.

In still another alternative aspect, the touch screen display includes an indicator of a component of light provided by the variable source of light. In another aspect, the indicator is a value representative of the component of the light provided by the variable source of light.

In a still further aspect, the inflatable photo booth of the present invention further comprises communications means for communicating a photograph taken by the camera/display assembly to a server remote from the inflatable three dimensional structure.

These and other objectives of the present invention will become obvious to those of ordinary skill in the art after reading the following detailed description of the preferred embodiments. It is to be understood that the foregoing general description and the following detailed description are exemplary, and are intended to provide further explanation of the invention as claimed.

### BRIEF DESCRIPTION OF THE DRAWINGS

Embodiments of this invention may best be understood by referring to the following description and accompanying drawings that are used to illustrate the invention. In the drawings:

FIG. 1 is a left side perspective view of one embodiment of the inflatable photo booth in accordance with principles of the present invention;

FIG. 2 is frontal view of a wall of the embodiment of FIG. 1;

FIG. 3 is a cross-sectional view of the wall of FIG. 2;

FIG. 4 is right side perspective view of the inflatable photo booth;

FIG. 5 is a rear perspective view of the inflatable photo booth;

FIG. 6 is a rear-side perspective view of the inflatable photo booth;

FIG. 7 is a frontal view of one embodiment of a camera and display assembly shown in a lowered position;

FIG. 8 is a frontal view of the embodiment of FIG. 7 shown in a raised position;

FIG. 9 is a rear view of the camera and display assembly of FIG. 7.

FIG. 10 is a frontal view of another embodiment of a camera and display assembly shown in a lowered position;

FIG. 11 is a rear view of the cameral and display assembly of FIG. 10; and

FIG. 12 is a front view of controller in accordance with principles of the invention.

### DETAILED DESCRIPTION OF THE PREFERRED EMBODIMENTS

Embodiments of the present invention are described herein in the context of an inflatable photo booth. Those of ordinary skill in the art will realize that the following detailed description of the present invention is illustrative only and is not intended to be in any way limiting. Other embodiments of the present invention will readily suggest themselves to such skilled persons having the benefit of this disclosure.

Reference will now be made in detail to implementations of the present invention as illustrated in the accompanying drawings. The same reference indicators will be used throughout the drawings and the following detailed description to refer to the same or like parts.

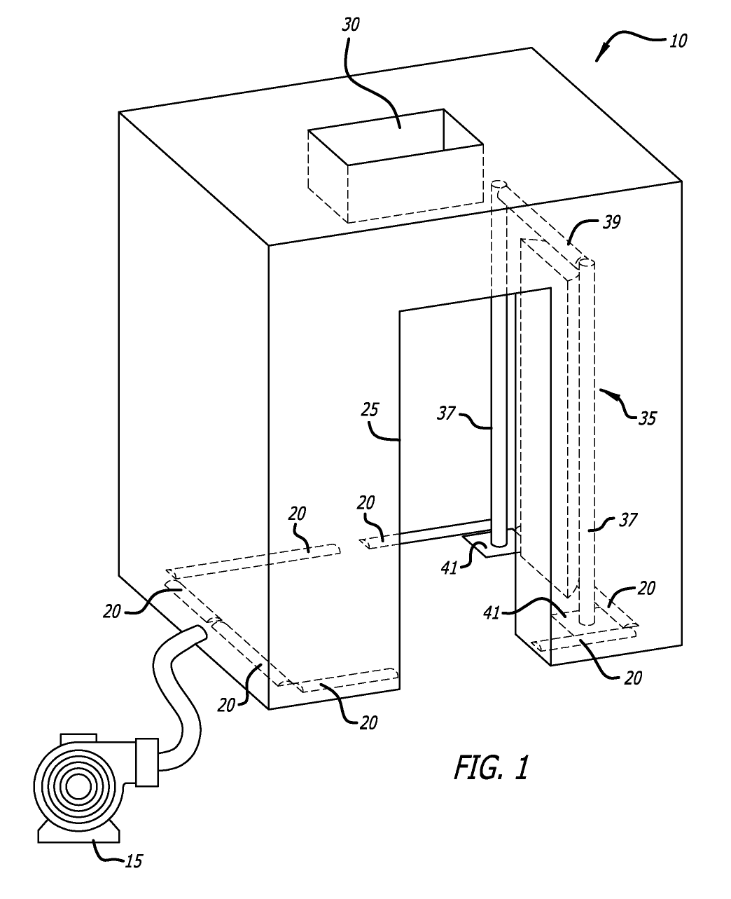

Referring now to FIGS. 1-3, in one embodiment, the present invention comprises an inflatable photo booth 10. The inflatable photo booth is made of an inflatable translucent membrane that requires air to function. The inflatable membrane is filled with air by means of a fan 15. The fan must be kept running while the photo booth is operational to maintain constant air pressure within the inflatable membrane. The constant air pressure coming from the fan also helps LED panels 20 maintain a low and stable temperature suitable for extended periods of use.

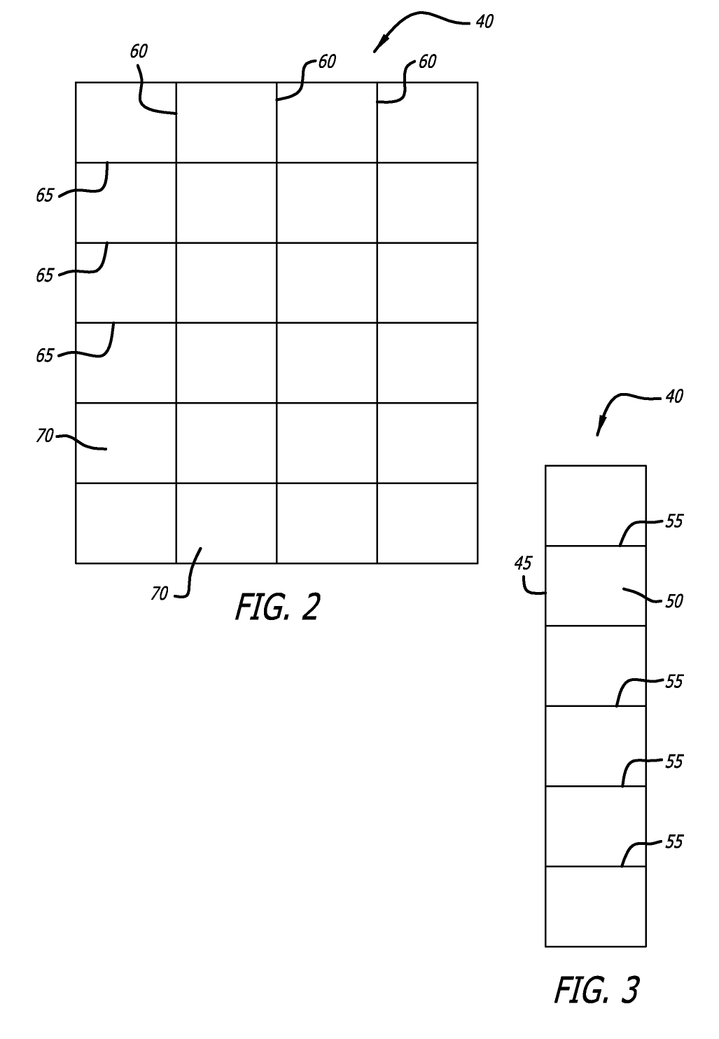

FIG. 2 illustrates an exemplary embodiment of a wall 40 of photo booth 10. As shown in FIG. 3, wall 40 has a front side 45 and a rear side 50. Front side 45 and rear side 50 are held at an approximately uniform distance from one other by a plurality of cord, straps or other flexible attachment members 55. The flexible attachment members allow for the free passage of air within the space created between the front and rear sides 45, 50 of wall 40, yet still allow wall 40 to be collapsed and rolled or folded when the photo booth 10 is deflated.

Also shown in FIG. 2 are a plurality of vertical seams 60 and a plurality of intersecting horizontal seams 65. The vertical and horizontal seams provide reinforcement to the membrane forming the front side and rear side of the wall. The seams also provide for attachment points for the flexible attachment members 55. In this manner, a strong yet flexible and translucent wall can be formed that allows for light to be transmitted within the space formed within the wall and also to allow light to transmit out of the wall to the exterior of the photo booth 10. This translucency is advantageous in that the lighting of LED panels 20, as will be discussed in more detail below, may be controlled to emit various colors, giving the exterior of the photo booth an attractive, exciting and inviting appearance. The various colors that can be generated by LED panels 20 also provide for interesting and varying effects that may be captured when a photograph is taken inside the photo booth.

Those skilled in the art will understand that the seams 60, 65 may be varied to produce various shaped panels 70 within the wall 40. For example, the panels 70 may be any shape desired, and do not have to be rectangular. The panels 70 may be relatively flat, even though they are under pressure from the air being pumped into the space within the wall created by front side 45 and rear side 50. Alternatively, the spacing of the seams may be adjusted such that the front side of panel 70 bows outward so that wall 40 takes on a quilt-like appearance.

When deflated, the body of the photo booth 10 possesses no discernible shape. In transit, a briefcase-like device or other easily transportable container (not shown) is used to secure and protect the photo booth and its removable parts. When inflated, the photo booth expands with air to expose all operating structures of the photo booth.

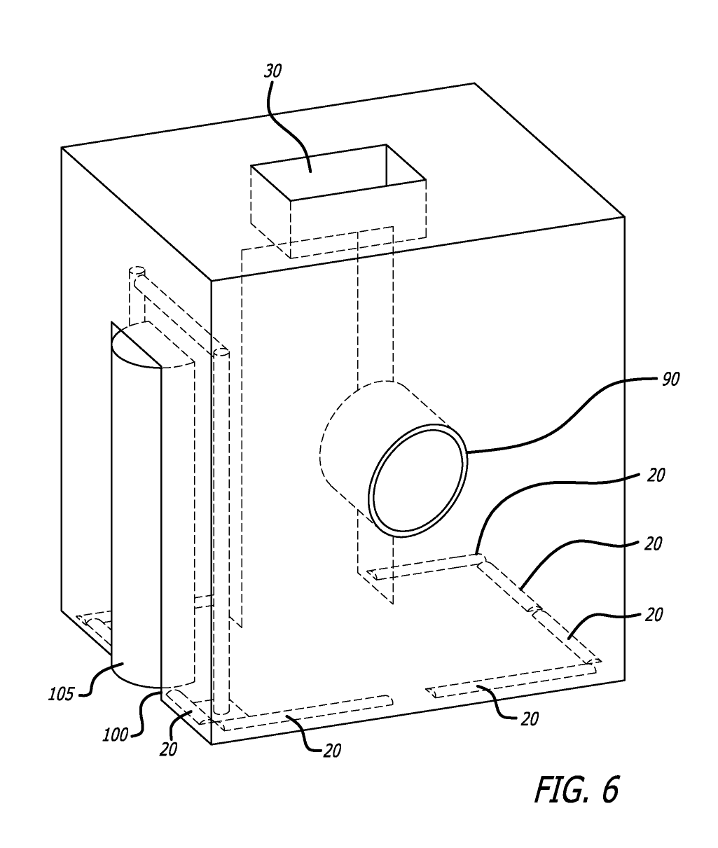

When inflated, the photo booth 10 is a single, generally squared structure with a single entrance and exit 25. There is a peek-a-boo window 90 (FIG. 6) and roof skylight 30 for proper light and air ventilation.

In some embodiments, an internal metal frame 35 comprised of two poles 37 positioned along the inside perimeter of the inflatable photo booth provides structure and support for the photo booth. The metal frame 35 comprises two poles 37 and upper strut bar 39 which adds more structural support and holds up two corner LED-lights or panels (not shown) to create a three point lighting set up. The metal frame also provides a means of attaching any other add-ons, such as extra lighting or other devices used while operating the photo booth. The two adjustable poles are removably attached to two metal bases 41. The attachment may be formed by inserting the metal poles into a hole/collar or other mount formed in or disposed on the base 41, or base 41 may include, for example, a vertically extending pin configured to mate with a socket formed at the base of the metal pole.

The metal poles 47 and upper strut 39 may be mounted to an inside wall, typically a side wall, of photo booth 10. In some embodiments, the poles are secured to a corner of the booth formed by the intersection of a side wall and the front or rear walls of the photo booth by way of strings, straps, velcro or similar devices that can removably fix the metal pole in place.

In a preferred embodiment, photo booth 10 measures approximately 7 feet wide, 8 feet high, and 7 feet deep, although the sizes may vary based on event at which the photo booth is to be used and location space limitations. The inflatable membrane is made of a durable, translucent material capable of resisting normal wear and tear during transportation and on-site assembly and disassembly.

The photo booth is designed for large groups of up to fourteen people to be used indoors and outdoors and typically on firm, solid surfaces. Furthermore, the structure is wheelchair accessible. For events with tighter spaces and smaller budgets, a smaller photo booth may be used.

Multiple internal and shatterproof LED-light panels 20 illuminate the translucent membrane of the photo booth. By using a Light Emitting Diode (LED), the LED-lit translucent membrane creates a soft box as compared to traditional photo booths which are permanent fixtures. As will be discussed in more detail below, the LED light panels 20 of the photo booth are controlled using a color wheel to choose the preferred color, ambiance, and can include multiple filters. This allows users to customize the lighting of the photo booth background with over 16,000 colors to choose from on a touchscreen monitor.

Infolds (not shown) along the underside of each end of the inflatable membrane walls allow insertion of the LED-light panels into the space created between front side 45 and rear side 50 of the walls. In some embodiments, these infolds are zippered slots that allow placement of the led panel into the wall, and are closed by way of a Velcro® “zipper” sewn into the wall to enclose the inserted LED panels, or other illuminating devices, once in place within the wall. In a typically sized inflatable photo booth 10, two LED-light panels 20 are placed into each infold and extend along the bottom perimeter of a wall of the photo booth, accounting for a total of eight LED-light panels; two in the front, two in the rear, and two on each side. Once inflated, the weight of the LED panels provides a base of support and help to keep the photo booth grounded. Of course, the number of LED panels 20 placed on each side of photo both is a function of the width of the wall, and can vary depending on the overall dimensions and shape of the photo booth.

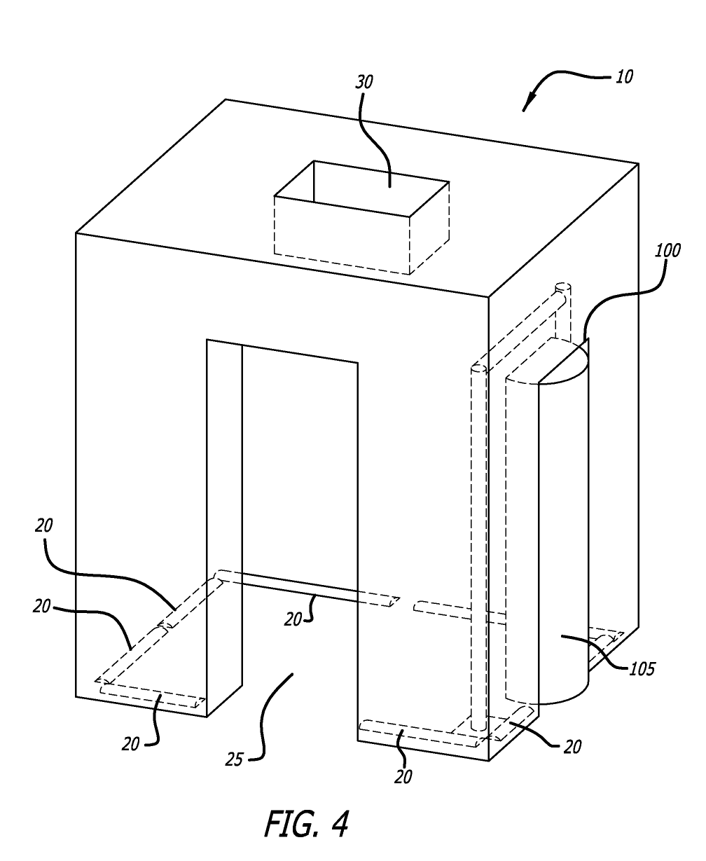

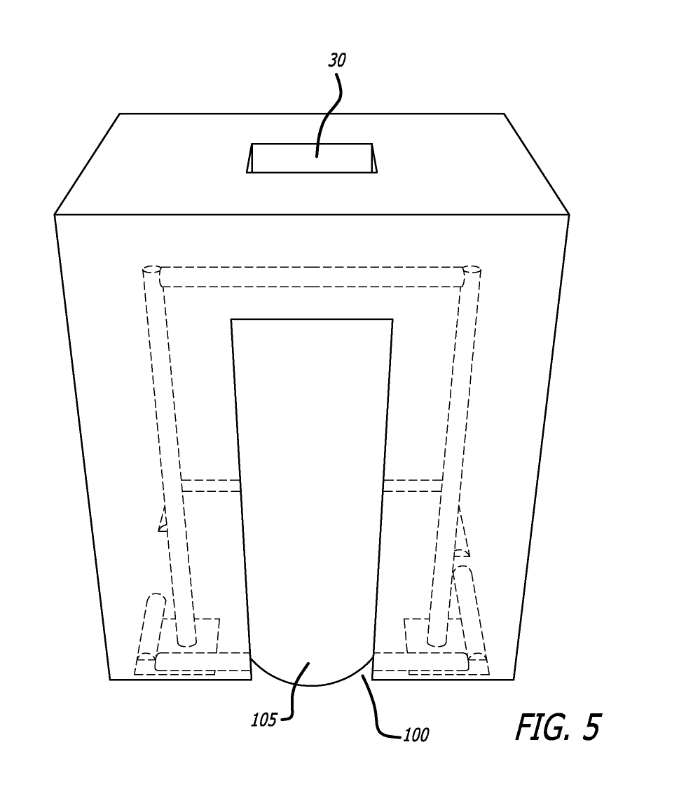

Referring now to FIGS. 4-6, one wall, typically a side wall adjacent to the wall including entrance 25, contains an opening 100 that encloses a portable kiosk that includes a camera/display assembly 105. This kiosk and camera/display assembly 105 includes a high quality Single Lens Reflex (DSLR) camera, two touchscreen monitors, and a dimmable LED panel. Step-by-step instructions appear on the screen inside the booth to allow for easy user operation. The housing unit also contains a built-in electronic lift so that users are not required to bend down or stand up on chair or bench to access the user interface. The height of the lift can be adjusted with the touch of a button, allowing users to spend more time to position themselves for the photo instead of worrying about fitting everyone inside of the viewfinder. The camera can also rotate 180 degree to take photos of even larger groups of people.

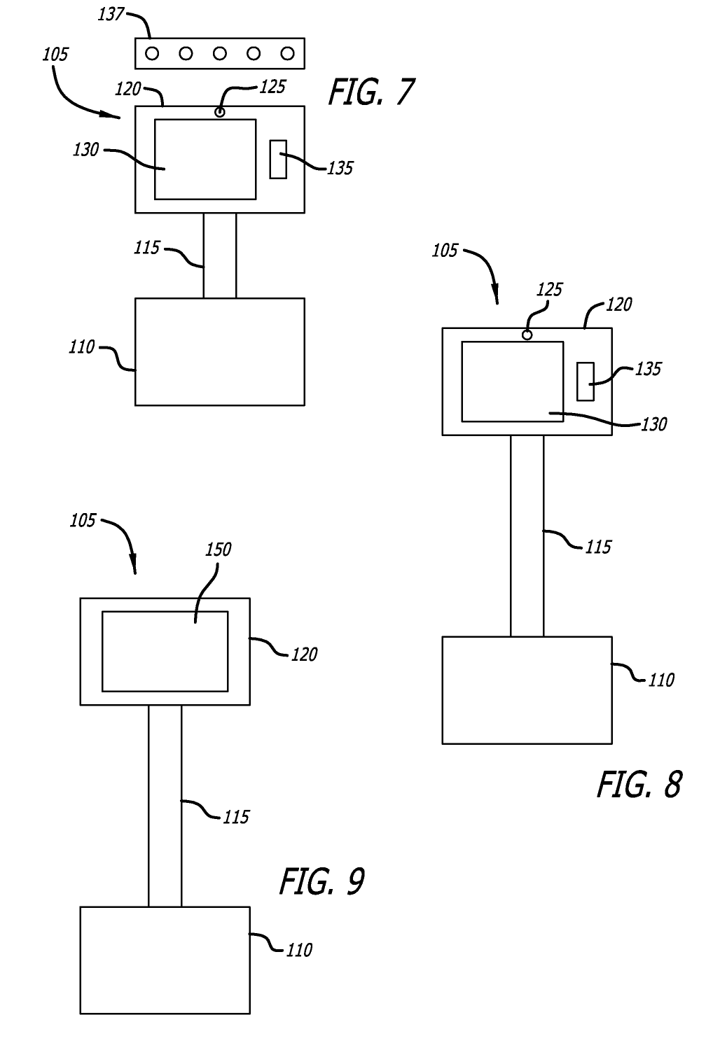

FIGS. 7 and 8 illustrate one embodiment of the camera/display assembly 105. In FIG. 7, the camera/display assembly 105 is shown in a lowered or retracted position. This embodiment includes a base 110 that supports a lift assembly 115 and upper module 120. FIGS. 7 and 8 are frontal views of the camera/display assembly 105, and illustrate the view of the assembly presented to users located within the photo booth.

Upper module 120 includes a camera 125 and a display 130. Camera 125 may be any CCD or CCD-like device, and has sufficient resolution to provide photos taken in a variety of light conditions that are pleasing to users of the photo booth. The display 130 may be an electronic display of any type having sufficient resolution and brightness so as to display a image captured by the camera to the user. Display 130 is used by the user to determine when the user or users are suitably composed for a desired photograph, and also to view a photograph that has been taken by the camera to determine whether the photograph is of sufficient quality or includes a pose that the user desires to store the photograph or print the photograph.

Base 110 is a housing that includes a processor and other electronics, such as a memory and communications port, used by the camera and display. For example, the processor may be part of a computer that includes a memory for storing images taken by the camera, and display electronics for providing the necessary display signals to the display 130. A communications port may also be includes that provides for communicating displayed images to a user's portable memory device, such as a portably flash drive, cell phone or other like device. The communications port may also provide for communications to a local or wide area network for communicating photographs taken in the photo booth to other users on the network. Additionally, the communications port may provide for communications through the Internet, so that a user may direct the processor to send the photograph as an email or attachment to an email, or to publish the photograph (including any accompany text) to social media, such as Instagram, Facebook and the like.

As shown in FIGS. 7 and 8, the upper module 120 including the camera/display assembly may be positioned at different heights. FIG. 7 shows the upper module in a lowered position or configuration, and FIG. 8 shows the upper module in a raised, extended position or configuration. Lift 115 provides for raising or lowering upper module 120, which may be accomplished using an electric motor to control a jack screw or similar mechanical lift. Alternatively, positioning of the upper module may be accomplished using a manual or hydraulic lift assembly. Of course, in its simplest embodiment, lift 155 may be replaced by a static mount that positions the upper module at a fixed, non-adjustable height.

A controller 135 is mounted, either fixed or removably, to the upper module 120. The controller may be operated by the user to select the lighting color or brightness to be used for taking the a photograph. The controller communicates with the processor in the base 110, and may be used to control other functions of the photo booth, as well as to control printing, emailing or publishing of the photograph.

FIG. 7 also shows a box light 137 that may optionally be used to supplement the light available from other lighting fixtures. In this embodiment, box light 137 may also controlled by the controller 135.

FIG. 9 illustrates a rear view of the camera/display assembly 125 of FIGS. 7 and 8. A mobile device or display 150 is positioned so that it is visible from outside of the inflatable photo booth. The display may be a touch screen, and allow access to various processes available through the processor located in the base 110 of the camera/display assembly. Alternatively, display 150 may also be associated with a control panel or controller (not shown) that allows for operation of the various functions of the booth by a user.

The display 150 serves two purposes. First, it shuttles guests away from the inside of the booth, making sure there are no long lines to wait in to get a picture taken. Second, because of the growing popularity of social media, users, through use of the touch panel, control panel or controller, have the ability to view all of the event pictures, edit them, delete them, and send them to Facebook, Twitter, or email. Custom graphics for all photos may also be available using the controls associated with the display 150.

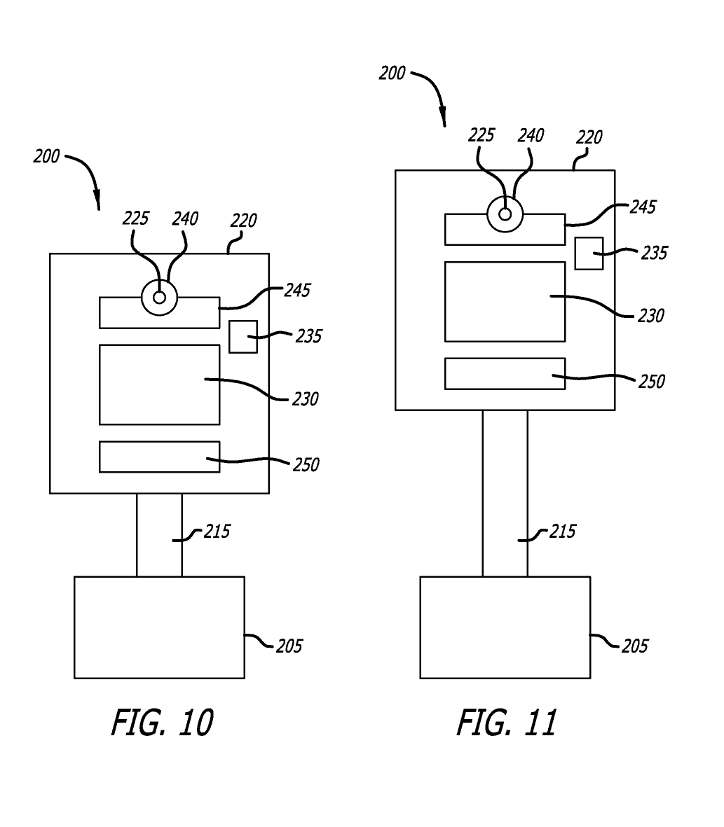

FIGS. 10 and 11 illustrate another embodiment of a camera/display assembly 200. In this embodiment, camera/display assembly includes a base 205, a lift 215 and an upper module 220. As discussed previously, the base may contain a processor (or computer), as well as mechanical, electrical, or hydraulic equipment as necessary to control lift 215.

Upper module 220 includes a camera 225 and a display 230. Display 230 may be a touch screen monitor. Also included, as described previously, is a controller 235.

Upper module 220 may additionally include various lighting fixtures so as to ensure that the lighting within the photo booth is balanced. In some embodiments, this light supplements the lighting providing by LED panels 20 (FIG. 1) Battery powered lights may also be suspended from the upper strut bar 39 of metal frame 39 (FIG. 1), or supplemental light may be provided by a softbox light arrangement known in the art.

Additional supplemental lighting may be provided by an LED ring light 240 disposed around camera 225. Where even more lighting is desired, light panels 245 and/or 250 may be mounted on the upper module 220. All of the lighting available may be controlled using the controller 235.

FIG. 10 illustrates the camera/display assembly in a lowered position. FIG. 11 illustrates the camera/display in a raised or extended position. One advantage of the various embodiments of the camera/display is that the upper module can be positioned by a user so that the user can take photographs of various user poses without requiring the user to bend down, or sit on a chair so as to put the user's face in line with the camera.

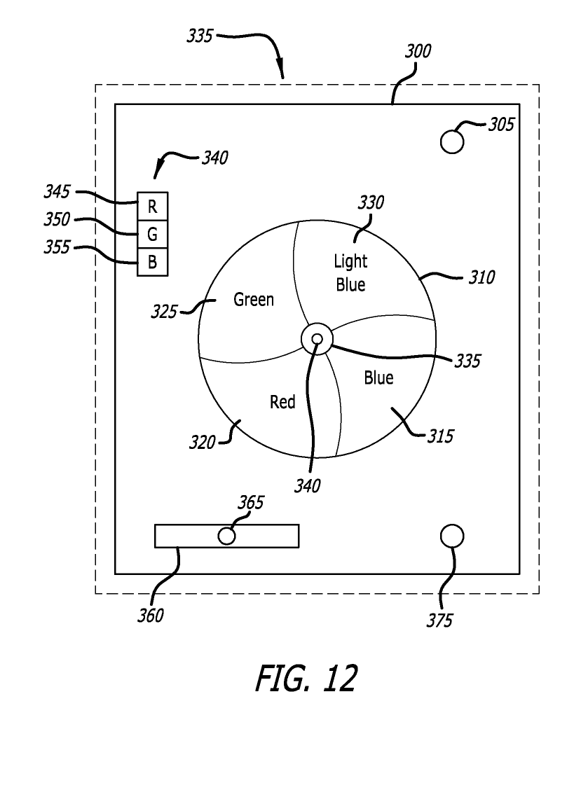

FIG. 12 illustrates one embodiment of a controller 335 in accordance with the present invention. Controller 335 is typically configured to be hand held, and may have any form factor deemed desirable, such as, for example only, and not limited to, the shape of an iPhone or other cell phone, mini-tablet, tablet, television-style remote control, and the like. Although one particular arrangement of features is disclosed below, other features or arrangements may be added to the controller without departing from the intended scope of the invention. Moreover, one skilled in the art will understand that the arrangement of controls or features on the controller is not limiting to the invention, as the location of controls or features may be varied depending on needs of a particular controller.

Controller 335 includes a processor and a memory for storing control information, as well any other data pertaining to the photographs being taken, The processor is controlled by appropriate software that incorporate commands that instruct the processor to accept input from a user, and to control the various aspects of the photographic process, as well as the environment of the interior of the photo booth, notably the lighting of the photo booth. The controller is also configured to communicate with the processor located in the base 105 of the camera/display assembly 120 (FIG. 1).

Typically, controller 335 will include a touch screen display 300. Button 305 (which may also be touch activated) is used to turn the display 300 of the controller on or off.

Touch screen 300 is also configured to display a number of touch sensitive controls for controlling the lighting of the photo booth, such as the color and brightness of LED panels 20 (FIG. 1), or the ring light 240 or supplemental lights 245, 250 (FIG. 10). Among those touch sensitive controls is a color wheel 310.

Color wheel 310 is a touch sensitive display that allows a user to use a finger or stylus to interface with the color wheel to change the color of the lighting provided by the various lighting elements of the photo booth described above. Generally, the color wheel has sections showing different colors, such as, for example, section 315, which includes shades of blue, section 320, which includes shades of red, section 325, which includes shades of green, and section 330, which includes shades of light blue. While the color wheel illustrated in FIG. 12 is shown having four distinct sections, in practice, the display would show a continuous change in shades of the colors red, green and blue from one to another in a manner familiar to those skilled in the art.

Color wheel 310 may also include a central touch button 335, the activation of which places the light in a neutral tone. In some embodiments, there may also be an indicator light 340 that indicates the status of the controller.

Touch screen 300 may include an RGB indicator panel 340. This panel includes individual displays indicating the intensity of each red, blue and green component that has been selected by the user during manipulation of the color wheel 310. For example, red display 345 displays a numeric value associated with the intensity of the red light component selected by the user on the color wheel, green display 350 displays a numeric value associated with the intensity of the green light component selected by the user, and blue display 355 displays a numeric value associated with the intensity of the blue light component selected by the user. As those skilled in the art understand, the various intensities (also called hues) combine to create light of certain color, which color is then used to illuminate the photo booth during a photographic session. In this manner, a user may select a particular lighting scheme to provide a desired photographic effect.

Additionally, touch screen 300 includes a light brightness slider bar 360. Light brightness slider bar 360 includes a touch button 365. Touch button 365 may be manipulated by a user to increase or decrease the brightness of the light produced by the various lighting elements of the photo booth. The position of touch button 365 along the light brightness slider bar 360 provides the user with a visual cue as to how the bright the lights will be.

In some embodiments of the controller, manipulation of the controls of the controller will activate the lighting in real time, that is, changes to the color of the light inputted by activating the color wheel 310, and to the brightness of the light by manipulating touch button 365, may be reflected in real time changes to the color and brightness of the lighting of booth. In other embodiments, the settings may be saved by pressing touch 375, which causes the settings of the color wheel and brightness controls to be stored in the memory of the controller.

Other embodiments of the controller 335 may include more than one color wheel or brightness slider bar to control various lighting elements independently of each other. For example, controller 335 may provide one color wheel and brightness slider bar to control LED panels 20 (FIG. 1), another color wheel and brightness slider bar to control light panels 234, 250 (FIG. 10), and a separate color wheel and brightness slider bar to control ring light 240 (FIG. 10). Alternatively, a single color wheel may be provided to control the color of all light elements, but also include more than one brightness slider bar to control the brightness of specific lighting elements. Any combination of color wheels and/or brightness slider bars that are possible are intended to fall within the scope of the invention.

Photo prints may be delivered on-site using Dye Diffusion Thermal Transfer (also known as D2T2), a very high-end technology for digital printing. These prints have a special over-coating that makes them waterproof, greatly lengthening the photo storage time up to 100 years. These prints can be developed within 12 seconds and are available with multiple print template options. The photographs may be communicated to the printer over a wired or wireless network, using a variety of technologies, such as Wi-Fi, RF, BlueTooth and the like.

The inflatable photo booth is also equipped with monitors to provide users with a live-view for two purposes. First, the live monitors allow the guests waiting outside the booth to see a real-time display of what is happening inside the booth. Second, the live-view monitors can switch into screen-saver mode and have the capability of showing a dynamic slideshow of the event photos.

As discussed previously a processor-implemented software system is utilized to operate the camera, flash, touch screen, and printer. The system receives input from the user through the touch screen and takes photos in a series. When all photos are taken and all edits have been made, the processor-implemented software system prints the images for the users. The various embodiments of the present invention are typically not coin or money operated, although the processor-implemented system can be modified to accept payments.

While the above description contains specific details regarding certain elements, sizes, and other teachings, it is understood that embodiments of the invention or any combination of them may be practiced without these specific details. Specifically, although shapes and colors are designated in the above embodiments, any shape and color may be used. These details should not be construed as limitations on the scope of any embodiment, but merely as exemplifications of the presently preferred embodiments. In other instances, well known structures, elements, and techniques have not been shown to clearly explain the details of the invention.

I claim:

1. An inflatable photo booth, comprising:
an inflatable three dimensional structure defined by a wall and a ceiling, the wall and ceiling each having an inside panel facing an interior of the inflatable three dimensional structure and an outside panel, the inside panel and the outside panel being attached to each other such that a space is formed between the inside and outside panels, the space providing a reservoir for the containment of air;
a source of air for filling the reservoir so as to inflate the three dimensional structure;
a variable source of light disposed about a bottom of the wall and in between the inside panel and the outside panel of the wall;
a first opening disposed in the wall to provide access to the interior of the inflatable three dimensional structure;
a camera/display assembly disposed in a second opening disposed in the wall such that a rear side of the camera/display assembly is visible from the exterior of the three dimensional structure; and,
a controller for controlling the variable source of light and the camera/display assembly.

2. The inflatable photo booth of claim 1, wherein the three dimensional structure has a rectangular shape.

3. The inflatable photo booth of claim 1, wherein the source for air is a fan or blower.

4. The inflatable photo booth of claim 1, wherein the variable source of light is an LED panel.

5. The inflatable photo booth of claim 1, wherein the camera/display assembly includes a camera and a touch screen display mounted on a front side of the camera/display assembly, the front side of the camera/display assembly facing into the interior of the inflatable three dimensional structure.

6. The inflatable photo booth of claim 5, wherein the camera/display assembly includes a touch screen display mounted on a rear side of the camera/display assembly, the touch screen being visible from the exterior of the inflatable three dimensional structure.

7. The inflatable photo booth of claim 1, further comprising a metal frame disposed in the interior of the inflatable three dimensional structure.

8. The inflatable photo booth of claim 1, wherein the camera/display assembly has an upper module supported on a base by a vertically adjustable member.

9. The inflatable photo booth of claim 8, wherein the upper module has a housing to which are mounted a camera and a touch screen display.

10. The inflatable photo booth of claim 9, wherein the camera and touch screen display are mounted on a front side of the upper module, and further including a second touch screen display mounted on a rear side of the upper module.

11. The inflatable photo booth of claim 7, wherein the distance between the upper module and the base can be adjusted by adjusting the vertically adjustable member.

12. The inflatable photo booth of claim 1, wherein the base includes a processor and a memory associated with the processor, the processor configured by software commands to receive commands from the controller and/or camera/display assembly to control operation of the variable source of light and camera/display assembly.

13. The inflatable photo booth of claim 1, wherein the controller includes a processor and a touch screen display controlled by the processor, the touch screen display controlled by the processor to display an adjustable color wheel and an adjustable brightness slider bar.

14. The inflatable photo booth of claim of 13, wherein the controller includes communication means for communication with the processor in the base of the camera/display assembly to provide the processor in the base with input for use by the processor in the base to control operation of the variable source of light and the camera/display assembly.

15. The inflatable photo booth of claim 13, wherein the adjustable color wheel is manipulable by a user to adjust a color value of light provided by the variable source of light.

16. The inflatable photo booth of claim 13, wherein the adjustable brightness slider bar is manipulable by a user to adjust a brightness value of light provided by the variable source of light.

17. The inflatable photo booth of claim 15, wherein the touch screen display includes an indicator of a component of light provided by the variable source of light.

18. The inflatable photo booth of claim 17, wherein the indicator is a value representative of the component of the light provided by the variable source of light.

19. The inflatable photo booth of claim 1, further comprising communications means for communicating a photograph taken by the camera/display assembly to a server remote from the inflatable three dimensional structure.
